(19) United States
(12) Patent Application Publication
(10) Pub. No.: US 2007/0052715 A1
(43) Pub. Date: Mar. 8, 2007

(54) Device, system and method of graphics processing

(76) Inventors: Konstantin Levit-Gurevich, Kiryat Byalik (IL); Raz Peleg, Kiryat Tivon (IL); Lev Zlotin, Khadera (IL)

Correspondence Address: PEARL COHEN ZEDEK LATZER, LLP, 1500 BROADWAY, 12TH FLOOR, NEW YORK, NY, 10036, US

(21) Appl. No.: 11/219,684

(22) Filed: Sep. 7, 2005

(51) Int. Cl. G06F 15/167

(52) U.S. Cl. 345/542

(57) ABSTRACT

Some embodiments of the invention provide devices, systems and methods of graphics processing. For example, a device in accordance with an embodiment of the invention includes a virtual machine monitor to replace a first memory address reference of a graphics instruction intended for execution by a graphics device of a computing platform with a second memory address reference corresponding to a physical memory address of said graphics device.

### BACKGROUND OF THE INVENTION

In the field of computing, a processor of a computing platform may execute instructions invoked by a Virtual Machine (VM), e.g., to simulate the operation of a certain Operating System (OS) or application. For example, a guest OS may be simulated within a host OS using the VM environment. Unfortunately, if the guest OS attempts to directly access certain hardware resources, the computing platform may become unstable, may crash, or may behave unexpectedly.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a computing platform including a guest Operating System (OS) able to utilize an Integrated Graphics Device (IGD) in accordance with an embodiment of the invention; and

FIG. 2 is a schematic flow-chart of a method of processing graphics in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

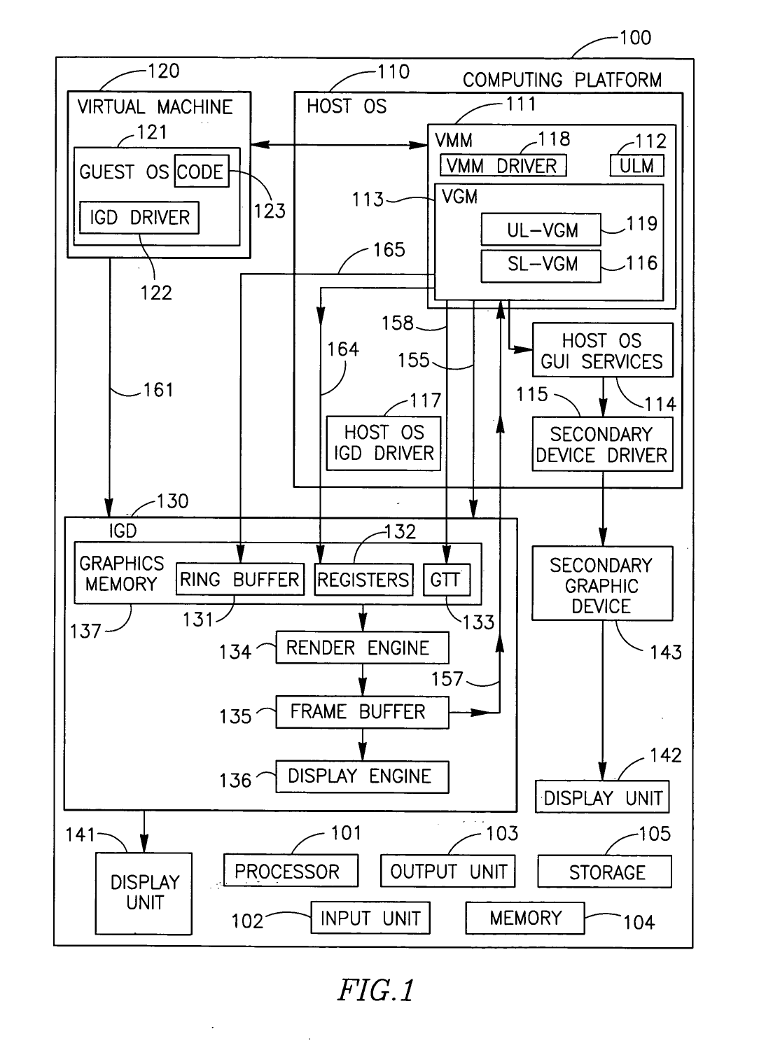

FIG. 1 schematically illustrates a block diagram of a computing platform 100 having a guest Operating System (OS) 121 able to utilize an Integrated Graphics Device (IGD) 130 in accordance with an embodiment of the invention. Computing platform 100 may include, for example, a host OS 110 having a Virtual Machine Monitor (VMM) 111 able to monitor and/or control the operation of one or more Virtual Machines (VMs). In one embodiment, for example, the guest OS 121 may be executed within a VM 120, which may be monitored and/or controlled using the VMM 111. Although one VM 120 and one guest OS 121 are shown, embodiments of the invention may optionally include multiple VMs and/or multiple guest OSs.

Computing platform 100 may further include one or more graphic devices, for example, IGD 130 and a Secondary Graphic Device (SGD) 143. For example, IGD 130 and/or SGD 143 may include a graphics card, a graphics processor, a graphics controller, a graphics accelerator, or the like. SGD 143 may be operatively connected to a display unit 142, and IGD 130 may optionally be operatively connected to a display unit 141.

In some embodiments, the IGD 130 may be disabled within the host OS 110. For example, a host OS IGD driver 117 may not be activated, or may be deactivated, within host OS 110, and host OS 110 may not be able to directly access the IGD 130. Host OS 110 may, for example, utilize the SGD 143 for display operations. In one embodiment, for example, the IGD 130 may be exclusively utilized and operatively associated with the guest OS 121 and/or the VM 120, whereas the SGD 143 may be exclusively utilized and operatively associated with the host OS 110.

In one embodiment, a single output unit 103 may be connected to the SGD 143, and IGD 130 may not be connected to display unit 141; in an alternate embodiment, IGD 130 may be connected to display unit 141. In some embodiments, for example, display unit 141 and/or display unit 142 may include a monitor, a screen, a window or area-of-interest within a monitor or screen, or the like. In one embodiment, display units 141 and 142 may be implemented using a single output unit 103 of computing platform 100; for example, display units 141 and 142 may be first and second windows, respectively, within output unit 103, e.g., side-by-side window or a first window within a second window. Other suitable implementations of one or more display units, and/or one or more windows, may be used.

The IGD 130 may include a graphics memory 137, for example, having a ring buffer 131, one or more registers 132, and a Graphics Translation Table (GTT) 133. Graphics memory 137 may store, for example, graphics data, background graphics data, texture data, frames data, vertex buffers, or the like. Registers 132 may include, for example, one or more memory mapped Input/Output (I/O) registers. The GTT 133 may allow conversion between a graphics memory address and a corresponding physical memory address. The ring buffer 131 may store graphics processing instructions and/or graphics rendering instructions, intended for execution by a render engine 134 of IGD 130.

In accordance with some embodiments of the invention, some graphics instructions stored in ring buffer 131 may include, e.g., as operands, references to a memory address of graphics memory 137, and such graphics instructions need not be modified or patched. Conversely, some graphics instructions stored in ring buffer 131 may include, e.g., as operands, references to a memory address external to the IGD 130, e.g., a memory address of VM 120; in accordance with some embodiments of the invention, such instructions may be modified or patched prior to their execution, such that the modified or patched instructions refer to a corresponding physical memory address, e.g., of host OS 110.

Additionally or alternatively, VM 120 may fill the GTT 133 with references to memory addresses; although the VM 120 may treat such references as references to physical memory address, the VM 120 does not have a physical memory of it own, and thus, in accordance with some embodiments of the invention, these memory references in the GTT 133 may be modified or patched. For example, the VMM 111 may monitor and/or control the access of the VM 120 to the GTT 133, and may replace the memory address references of the GTT 133 with references to corresponding physical memory address, e.g., of host OS 110.

Upon the execution of the graphics processing instructions or rendering instructions by the render engine 134, the execution results, e.g., in a data format suitable for presentation using a display unit, may be stored in a frame buffer 135, which may be operatively associated with a display engine 136. In one embodiment, the frame buffer 135 may be implemented as part of graphics memory 137.

The VMM 111 may operate as a user process in computing platform 100, e.g., on top of host OS 110. For example, VMM 111 may receive as input a disk image having installed therein the guest OS 121, and may monitor the operation of guest OS 121. The VMM 111 may include, or may be implemented using, for example, a User Level Monitor (ULM) 112, which may operate at a user privilege level and may actively monitor and/or control the operation of VM 120. The VMM 111 may further include a VMM driver 118, e.g., able to operate in ring-0 level, having direct access to one or more hardware components of computing platform 100. ULM 112 and/or VMM driver 118 may, for example, perform code scanning and/or code patching, e.g., to monitor and modify instructions intended for execution by VM 120 and/or guest OS 121.

The VMM 111 may further include a Virtual Graphics Monitor (VGM) 113, for example, implemented utilizing a Direct Graphics (DirectG) module. The VGM may include one or more components or modules, for example, a User Level VGM (UL-VGM) 119 and a System Level VGM (SL-VGM) 116. The VGM 113 may utilize the SGD 143, e.g., indirectly through a host OS Graphic User Interface (GUI) services module 114 and/or a secondary device driver 115, which may be included in host OS 110. The VGM 113 and/or the SL-VGM 116 may further control the IGD 130, for example, as indicated by link 155. The VGM 113 may perform virtualization operations, e.g., memory address modification or replacement operations, for example, when VM 120, guest OS 121 and/or a guest code 123 attempt to directly access the IGD 130.

The SL-VGM 116 may be implemented, for example, as a proxy IGD driver installed within host OS 110, and may activate, configure and/or control the IGD 130, e.g., through a Peripheral Component Interconnect (PCI) header. For example, SL-VGM 116 may allocate physical memory ranges of a memory unit 104 of the host OS 110 to one or more components of IGD 130, e.g., to registers 132 and/or GTT 133. The SL-VGM 116 may map physical memory addresses or memory ranges associated with IGD 130 components into a linear address space associated with read/write permissions. The SL-VGM 116 may deactivate the IGD 130 and release the allocated memory, e.g., when the guest OS 121 terminates an attempt to directly access the IGD 130. The SL-VGM 116 may optionally be used to disable the host OS IGD driver 117, e.g., by initializing the host OS IGD driver 117 in accordance with a pre-defined scheme which may be different from a default initialization scheme of the host OS IGD driver 117 when enabled in host OS 110. In some embodiments, the SL-VGM may otherwise prevent access or direct access to the IGD 130 by the host OS 120.

The guest OS 121 may include an IGD driver 122, e.g., installed therein. During the operation of the guest OS 121, and/or during the execution of guest code 123, the IGD driver 122 may attempt to directly access the IGD 130. The VMM 111, which may monitor the operations of guest OS 121, may detect the attempt and may instruct the VGM 113 to handle the attempt. The VGM 113 may perform virtualization operations (“virtualization work”), for example, by modifying an instruction, a data item, or a pointer to a memory address, written by the IGD driver 122, with replacement instruction, data item, or pointer, respectively. For example, the IGD driver 122 may write, into ring buffer 131, registers 132 and/or GTT 133, a graphics instruction or a data item referring to a first memory address; VGM 113 may modify or replace the instruction or data item, using links 164, 165 or 158, respectively, such that the modified or replaced instruction or data item refers to a second, different memory address, e.g., a physical memory address of the host OS 110 corresponding to the first address (“virtualized address”).

In some embodiments, for example, VMM 111 may detect that the VM 120, the guest OS 121, the IGD driver 122, and/or the guest code 123 attempts to directly access the IGD 130. This may be performed, for example, by monitoring or intercepting instructions intended for execution within VM 120 or by IGD 130, e.g., using an interception module or a monitoring module included in VMM 111. Upon such detection, VMM 111 and/or VGM 113 may, for example, modify the instruction which is about to be executed within the IGD 130, e.g., by replacing a first memory address to which the guest OS 121 or guest code 123 referred, with a second, corresponding memory address. This may allow the VM 120, the guest OS 121, the IGD driver 122, and/or the guest code 123 to directly access the IGD 130, e.g., using the virtualized address which is replaced or inserted by the VMM 111. In some embodiments, these operations may be performed, for example, in a user privilege level and/or without invoking the host OS IGD driver 117 of the host OS 110.

In some embodiments, when the guest code 123 attempts to directly access a component of the IGD 130, e.g., graphics memory 137 or portions of ring buffer 131, the VGM 113 may provide the guest code 123 with a pointer to a physical memory address of the host OS 110 which corresponds to the memory address that the guest code 123 attempts to directly access. This may allow the guest code 123 to directly access the IGD 130 from within the VM 120 using link 161, and/or to directly access components of the IGD 130. Accordingly, some embodiments may obviate the need of VMM 111 to gain control of the flow of execution (“VM-exit”), to emulate execution of a guest code 123 operation (“virtualization work”), to resume the execution of the guest code 123 (“VM-entry”), and/or to use a serial line buffer and computing resources to simulate graphic processing. Instead, the IGD driver 122 installed within the guest OS 121 may directly control the IGD 130, which may natively execute instructions stored in the ring buffer 131 and perform the rendering operations using the render engine 134.

Some embodiments may utilize a pre-defined update process, storage scheme, timing scheme or synchronization scheme, to ensure that the render engine 134 may not execute graphics instructions prior to their modification or patching by VGM 113. For example, in one embodiment, ring buffer 131 may include multiple portions or multiple registers, e.g., a base register, a size register, a head register, and a tail register. The IGD 130 may, e.g., periodically or substantially continuously, compare the content of the head register and the content of the tail register. If the content of the head register is identical to the content of the tail register, than no graphics instruction is executed, e.g., by the render engine 134. Conversely, if the content of the head register is different than the content of the tail register, then the render engine 134 may execute the graphics instruction stored in a graphics memory address to which the head register points, and the head register may be updated to point to the next graphics instruction intended for execution. The tail register may point to the first available memory address after one or more graphics instructions intended for execution. VM 120 may write, using the IGD driver 122, one or more new graphics instructions into graphics memory 137, at the graphics memory address to which the tail register points, and may attempt to modify the content of the tail register to point to the end of the newly-written instruction(s). The VMM 111 may monitor and detect the attempt of VM 120 to modify the content of the tail register, may scan and patch the new graphics instructions that the VM 120 wrote into graphics memory 137, and may then update the content of the tail register to point to the end of the newly-written instructions. This may allow the render engine 134 to execute a newly-written instruction, written by VM 120 into graphics memory 137, only after VMM 111 modifies the instruction, if needed. In some embodiments, VMM 111 may dynamically or selectively monitor, control, intercept or limit the direct access of VM 120 to components of IGD 130; for example, VMM 111 may allow VM 120 to directly write graphics instructions into frame buffer 131, and may not allow VM 120 to directly modify the content of the tail register. Other suitable writing privileges or limitations may be used.

In one embodiment, display unit 141 may be connected to the IGD 130, and may present images generated natively by the IGD 130 controlled directly by the guest code 123. In an alternate embodiment, e.g., when IGD 130 is not connected to a display unit, the VGM 113 may handle the presentation of generated natively by the IGD 130. For example, the VGM 113 may emulate the operations of display engine 136, and, as indicated by arrow 157, may obtain image data stored in frame buffer 135 to present the image data using the SGD 143 and display unit 142. In one embodiment, the emulation operations using the VGM 113 may take into account values of registers 132, and may optionally display the image data inside a dedicated window within display unit 142, e.g., using the host OS GUI services module 114.

In some embodiments, computing platform 100 may include or utilize a platform simulator environment to allow a user to switch between multiple modes of operations. In a first mode, guest code 123 may have virtualized access to the IGD 130, through the VMM 111 which may perform virtualization work, e.g., memory address remapping, and scanning and patching of the content of ring buffer 131. In a second mode, the guest code 123 may have native, direct access to the IGD 130, while the VGM 130 may replace or modify memory pointers to allow the native access. In some embodiments, image data produced by the guest code 123 may be presented using dedicated display unit 141, or a dedicated window within display unit 142. Computing platform. 100 may allow switching between the first and second modes, or vice versa; for example, the VGM 114 may save the state of the IGD 130 upon switching from the first mode to the second mode, and may restore the saved state upon switching back from the second mode to the first mode.

Computing platform 100 may further include other suitable hardware components and/or software components, for example, a processor 101, an input unit 102, memory unit 104, and a storage unit 105.

Processor 101 may include, for example, a Central Processing Unit (CPU), a Digital Signal Processor (DSP), a microprocessor, a controller, a chip, a microchip, an Integrated Circuit (IC), or any other suitable multi-purpose or specific processor or controller. The processor 101 may, for example, execute instructions of the guest OS 110, may execute instructions to operate VMM 111 and/or VGM 113, may execute instructions to operate the VM 120 and/or guest OS 121 and/or guest code 123, or the like.

Input unit 102 may include, for example, a keyboard, a keypad, a mouse, a touch-pad, a pointing device, a microphone, a voice-recognition unit, or other suitable input device. Memory unit 104 may include, for example, a Random Access Memory (RAM), a Read Only Memory (ROM), a Dynamic RAM (DRAM), a Synchronous DRAM (SD-RAM), a Flash memory, a volatile memory, a non-volatile memory, a cache memory, a buffer, a short term memory unit, a long term memory unit, or other suitable memory units or storage units. Storage unit 105 may include, for example, a hard disk drive, a floppy disk drive, a Compact Disk (CD) drive, a CD-ROM drive, or other suitable removable or non-removable storage units.

Some embodiments of the invention may allow various benefits, including, for example, allowing a host-based VMM to support advanced graphics virtualization closer to a native speed and substantially without degrading the host OS graphics performance; resolving or preventing a possible conflict between a host OS and a guest OS; eliminating a need for an additional graphics card, e.g., by utilizing an internal IGD; eliminating the need for an additional display unit, e.g., by presenting the image data generated by the guest code in a dedicated window on top of the host OS; allowing graphics rendering to be performed natively by the guest OS, and making additional simulated CPU resources available for other simulated work, thereby producing a realistic simulation of the workload in the VM; and/or other benefits.

Although portions of the discussion herein may relate, for demonstrative purposes, to a computing platform having a single VM 120 and single guest OS 121, embodiments of the invention are not limited in this regard, and may include, for example, a computing platform having multiple VMs and/or multiple guest OSs.

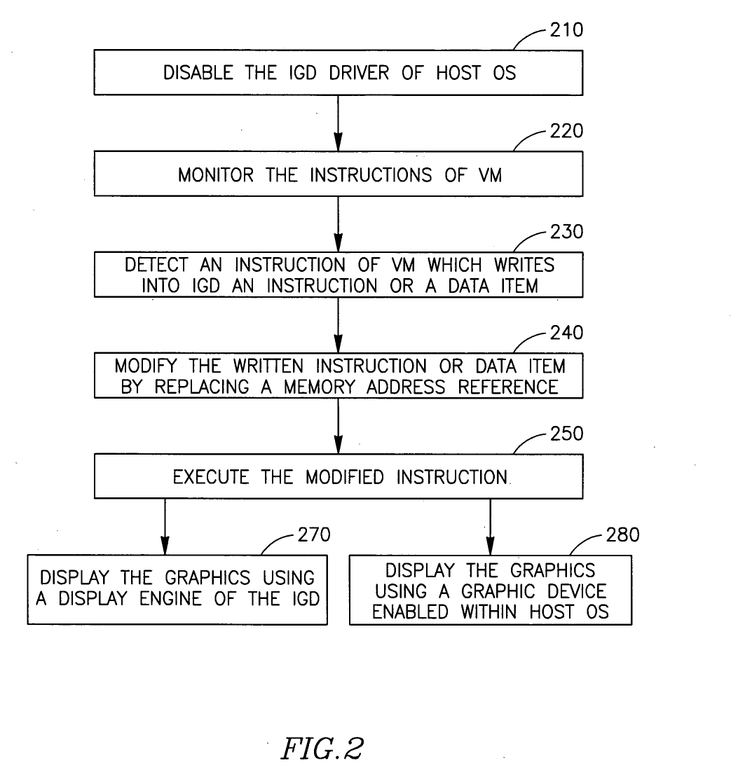

FIG. 2 is a schematic flow-chart of a method of processing graphics in accordance with an embodiment of the invention. The method may be used, for example, by computing platform 100 of FIG. 1, or by other suitable components, processors, controllers, VMMs, VMs, or the like.

Optionally, suitable preparatory operations may be performed prior to the method in accordance with some embodiments of the invention. Such preparatory operations may include, for example, creating one or more VMs, for example, creating VM 120 of computing platform 100 using VMM 111.

As indicated at box 210, the method may include, for example, disabling the IGD driver 117 of host OS 110. This may optionally include, for example, initializing the IGD driver 117 of the host OS 110 using SL-VGM 116, e.g., using an initialization scheme different from the default initialization scheme of the IGD driver 117.

As indicated at box 220, the method may include, for example, monitoring the instructions of VM 120, e.g., substantially continuously.

As indicated at box 230, the method may include, for example, detecting an instruction of VM 120 which writes a graphics instruction or a graphics data item into a component of the IGD 130, e.g., into ring buffer 131 or registers 132.

As indicated at box 240, the method may include, for example, modifying the written graphics instruction or graphics data item within the IGD 130, e.g., by replacing a reference to a first memory address with a reference to a second, different memory address, e.g., corresponding to a physical memory address. This may include, for example, replacing, overwriting, or otherwise inserting the second address, or a pointer to a virtualized address, instead of a memory address or a pointer to a memory address written by the VM 120, respectively.

As indicated at box 250, the method may include, for example, natively executing the modified graphics instruction by the IGD 130. This may include, for example, rendering graphics within the IGD 130 based on data and/or instructions provided by the VM 120 and replaced or modified by the VMM 111. The execution of the graphics instructions may be performed by render engine 134, and may include, for example, storing the resulting graphics data in frame buffer 135.

As indicated at box 270, the method may optionally include, for example, displaying the graphics represented by the data stored in frame buffer 135 using display engine 136 of IGD 130, e.g., utilizing a dedicated display unit 141.

Additionally or alternatively, as indicated at box 280, the method may optionally include, for example, displaying the graphics represented by the data stored in frame buffer 135 using a graphic device enabled within host OS 110, e.g., using SDG 143 and display unit 142. This may include, for example, utilizing the host OS GUI services 114 and secondary device driver 115 to present the graphics represented by the data stored in frame buffer 135. In some embodiments, the graphics may optionally be presented in a first window, which may be located within or in proximity to a second window presenting host OS applications or host OS desktop.

Other suitable operations or sets of operations may be used in accordance with embodiments of the invention.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by computing platform 100, by processor 101, by VMM 111 or by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 104), memory device, memory article, memory medium, storage device, storage article, storage medium and/or storage unit (e.g., storage unit 105), for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus comprising:
a virtual machine monitor to replace a first memory address reference of a graphics instruction intended for execution by a graphics device of a computing platform with a second memory address reference corresponding to a physical memory address of said graphics device.

2. The apparatus of claim 1, comprising a virtual machine to transfer said graphics instruction to said graphics device.

3. The apparatus of claim 1, wherein said virtual machine monitor is to replace said first memory address reference in a ring buffer of said graphics device.

4. The apparatus of claim 1, wherein said virtual machine monitor is to replace said first memory address reference in a register of said graphics device.

5. The apparatus of claim 1, wherein said virtual machine monitor is to detect said graphics instruction prior to execution of said graphics instruction by said graphics device.

6. The apparatus of claim 1, further comprising:
a display operatively connected to said graphics device to display graphics rendered by said graphics device based on said graphics instruction.

7. The apparatus of claim 1, further comprising:
a display operatively connected to a secondary graphics card of said computing platform, associated with a secondary device driver of said computing platform, to display graphics rendered by said graphics device based on said graphics instruction.

8. A computing platform comprising:
a virtual machine to write into a graphics memory a graphics instruction having a memory reference; and
a virtual machine monitor to detect said graphics instruction prior to its execution, and to replace said memory reference with a reference corresponding to a physical memory address of a graphics device.

9. The computing platform of claim 8, wherein said graphics device comprises said graphics memory.

10. The computing platform of claim 8, wherein said virtual machine monitor is to replace said memory reference in a ring buffer of said graphics device.

11. The computing platform of claim 8, wherein said virtual machine monitor is to replace said memory reference in a register of said graphics device.

12. The computing platform of claim 8, further comprising:
a dynamic Random Access Memory operatively associated with said virtual machine monitor.

13. A method comprising:
replacing a first memory address reference of a graphics instruction intended for execution by a graphics device of a computing platform with a second memory address reference corresponding to a physical memory address of said graphics device.

14. The method of claim 13, further comprising:
transferring said graphics instruction from a virtual machine to said graphics device.

15. The method of claim 13, wherein replacing comprises replacing said first memory address reference in a ring buffer of said graphics device.

16. The method of claim 13, wherein replacing comprises replacing said first memory address reference in a register of said graphics device.

17. The method of claim 13, further comprising:
detecting said graphics instruction prior to execution of said graphics instruction by said graphics device.

18. The method of claim 13, further comprising:
preventing access to said graphics card by a host operating system of said computing platform.

19. A machine-readable medium having stored thereon instructions that, if executed by a machine, result in:
replacing a first memory address reference of a graphics instruction intended for execution by a graphics device of a computing platform with a second memory address reference corresponding to a physical memory address of said graphics device.

20. The machine-readable medium of claim 19, wherein the instructions result in:
transferring said graphics instruction from a virtual machine to said graphics device.

21. The machine-readable medium of claim 19, wherein the instructions that result in replacing result in:
replacing said first memory address reference in a ring buffer of said graphics device.

22. The machine-readable medium of claim 19, wherein the instructions that result in replacing result in:
replacing said first memory address reference in a register of said graphics device.

23. The machine-readable medium of claim 19, wherein the instructions result in:
detecting said graphics instruction prior to execution of said graphics instruction by said graphics device.

24. The machine-readable medium of claim 19, wherein the instructions result in:
preventing access to said graphics card by a host operating system of said computing platform.
